(19) United States
(12) Patent Application Publication
(10) Pub. No.: US 2023/0204517 A1
(43) Pub. Date: Jun. 29, 2023

(54) OPTICAL DETECTION APPARATUS, OPTICAL DETECTING METHOD, AND IMAGE PROCESSOR

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: TIAN-TIAN FAN, Zhengzhou (CN); LI-MING ZHAO, Zhengzhou (CN); YUAN-FANG DU, Zhengzhou (CN)

(21) Appl. No.: 17/740,992

(22) Filed: May 10, 2022

(30) Foreign Application Priority Data
Dec. 29, 2021 (CN) 202111639341.X

(51) Int. Cl. G01N 21/88; G01N 21/95

(52) U.S. Cl. CPC G01N 21/8851; G01N 21/95; G01N 21/8806; G01N 2021/8835; G01N 2021/8883; G01N 2021/9511; G01N 2201/0628

(57) ABSTRACT

An apparatus to detect optical flatness of an OLED display layer includes a light-emitting assembly, a light-receiving assembly, and an image processor. The light-emitting assembly includes a light source and a first enhancement element. The light source emits reference light through the first enhancement element. The first enhancement element enhances brightness of the reference light and guides the enhanced reference light to a display layer of a display device being detected. The light-receiving assembly receives light reflected by the display layer according to the reference light and generates an image thereof. The image processor receives the image and obtains a result of detection as to surface flatness of the display layer according to the image.

### FIELD

The present disclosure generally relates to optical detection technology, particularly relates to an optical detection apparatus, an optical detecting method, and an image processor.

### BACKGROUND

An organic light emitting diode (OLED) display device generally includes a glass cover plate and a display layer. If a surface of the display layer is uneven, light from an external light source having different incident angles will cause interference after being reflected by the display layer due to material characteristics of the OLED, which results in a poor display, such as uneven brightness and uneven gray scales of the OLED display device.

A conventional flatness detection equipment can only detect a surface flatness of the glass cover plate but cannot detect a surface flatness of the display layer. Preventing poor display caused by uneven surface of the display layer is desired.

### BRIEF DESCRIPTION OF DRAWINGS

FIG. 1 is a view of a display device to be detected.

FIG. 2 is a view of an optical detection apparatus according to the present disclosure.

FIG. 3 is a flow chart of an optical detecting method according to the present disclosure.

FIG. 4 shows four image partitions formed by block S4 of the method in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The connection can be such that the objects are permanently connected or releasably connected. The term “comprising,” when utilized, means “including, but not necessarily limited to”; it specifically indicates open-ended inclusion or membership in the so-described combination, group, series, and the like.

When a feature or element is herein referred to as being “on” another feature or element, it can be directly on the other feature or element or intervening features and/or elements may also be present. It will also be understood that, when a feature or element is referred to as being “connected”, “attached” or “coupled” to another feature or element, it can be directly connected, attached, or coupled to the other feature or element or intervening features or elements may be present.

An optical detection apparatus of the present disclosure is used to detect a surface flatness of a display device, especially to detect a surface flatness of an internal structural layer (such as a display layer) of an organic light emitting diode (OLED) display device. In this embodiment, the optical detection apparatus is used to detect a surface flatness of the display layer inside the OLED display device. That is, in this embodiment, the display device to be detected is an OLED display device.

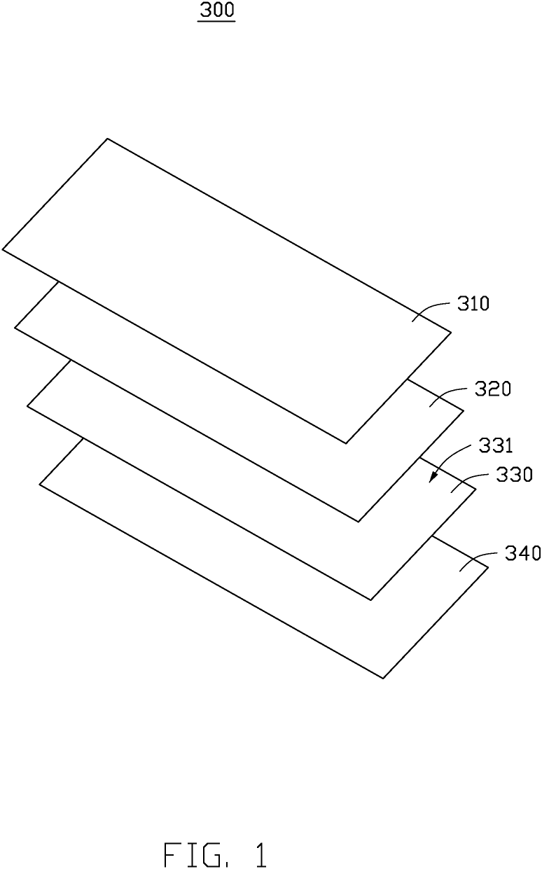

As shown in FIG. 1, a display device 300 to be detected includes a glass cover plate 310, a touch layer 320, a display layer 330, and a metal substrate 340, wherein the touch layer 320 is between the glass cover plate 310 and the display layer 330, and the display layer 330 is between the touch layer 320 and the metal substrate 340. The display layer 330 includes an OLED layer, a packaging layer, and a polarizing layer (not shown), wherein the polarizing layer is closer to the glass cover plate 310 than the OLED layer. The optical detection apparatus of this embodiment is used to detect a flatness of a surface 331 of the display layer 330 close to the glass cover plate 310 (that is, a top surface of the polarizing layer) when assembly of the display device 300 is completed.

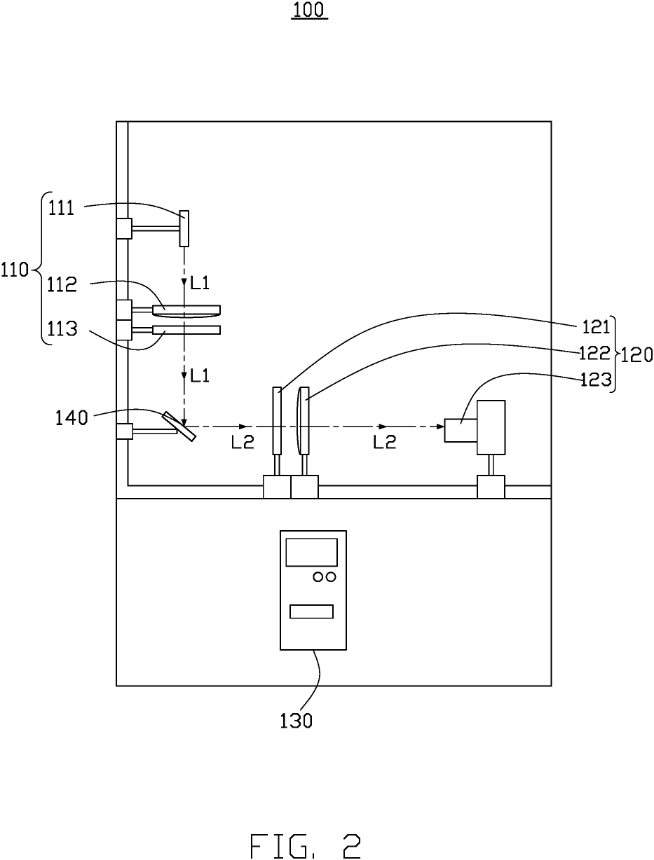

As shown in FIG. 2, in this embodiment, an optical detection apparatus 100 includes a light-emitting assembly 110, a light-receiving assembly 120, and an image processor 130.

As shown in FIG. 1 and FIG. 2, the light-emitting assembly 110 is configured to emit reference light L1. The display device 300 is on an optical path of the reference light L1 when the optical detection apparatus 100 is working. The reference light L1 will be reflected by the display device 300 when incident light falls on the display device 300, wherein light reflected by the display device 300 is defined as detection light L2. In this embodiment, the reference light L1 incident from a side of the glass cover plate 310 away from the display layer 330 penetrates the glass cover plate 310, reaches the surface 331 of the display layer 330, and is reflected by the surface 331.

In this embodiment, the optical detection apparatus 100 also includes a carrier 140. The carrier 140 is used to carry and fix the display device 300 when the optical detection apparatus 100 is working. In other embodiments, the optical detection apparatus 100 does not include the carrier 140, wherein the display device 300 is carried by a fixed device (such as a fixed platform, mechanical arm, etc.) other than the optical detection apparatus 100 when the optical detection apparatus 100 is working.

As shown in FIG. 2, in this embodiment, the light-emitting assembly 110 includes a light source 111 and a first enhancement element 112. The light source 111 is used to emit the reference light L1. In this embodiment, the light source 111 includes light-emitting diode(s) and is a surface light source. The reference light L1 is white light with a luminosity of about 2500 lux, and the reference light L1 is linearly polarized light with a polarization direction parallel to a surface of the glass cover plate 310. The reference light L1, not being reflected, has uniform brightness since the light source 111 is a surface light source, which is conducive to improve a detection accuracy. In this embodiment, the first enhancement element 112 is a lens for converging the reference light L1. Through a convergence effect of the first enhancement element 112 on the reference light L1, intensity of the reference light L1 from the first enhancement element 112 can be improved and compared to the reference light L1 from the light source 111, which is conducive for the reference light L1 penetrating the glass cover plate 310 to reach the surface 331 of the display layer 330.

In other embodiments, the first enhancement element 112 may be other structures that can enhance light intensity, such as a luminance-enhancing film.

In this embodiment, the light-emitting assembly 110 further includes a first selection element 113 on the optical path of the reference light L1. The first selection element 113 guides some of the reference light L1 from the first enhancement element 112 to the display device 300. The reference light L1 from the first enhancement element 112 may include diffused light (that is, reference light with large divergence angle), and the first selection element 113 filters the diffused light and guides the reference light L1 which is non-diffused to the display device 300.

In this embodiment, the first selection element 113 is a polarizer for filtering the diffused light and transmitting the non-diffused reference light L1. That is, in this embodiment, some of the reference light L1 is filtered by the first selection element 113 and the remaining reference light L1 is transmitted by the first selection element 113, wherein a divergence angle of the reference light L1 being filtered is greater than that of the reference light L1 being transmitted. In other embodiments, the first selection element 113 may be other elements with a selective light transmission function such as partially coated filter.

In this embodiment, the light-receiving assembly 120 includes a second selection element 121 and a second enhancement element 122. The second selection element 121 is on the optical path of the detection light L2 and is used to guide the detection light L2 reflected by the display layer 330 to the second enhancement element 122. The detection light L2 reflected by the display layer 330 may include diffused light, the second selection element 121 is used to filter the diffused light and guide the non-diffused detection light L2 to the second enhancement element 122.

In this embodiment, the second selection element 121 is a polarizer for filtering the diffused light and transmitting the non-diffused detection light L2. That is, in this embodiment, a portion of the detection light L2 is filtered by the second selection element 121 and the remaining detection light L2 is transmitted by the second selection element 121, wherein a divergence angle of the detection light L2 being filtered is greater than that of the detection light L2 being transmitted. In other embodiments, the second selection element 121 may be other element with selective light transmission function, such as partially coated filter.

In this embodiment, the second enhancement element 122 is a lens for converging the detection light L2 from the second selection element 121. Through the convergence, an intensity of the detection light L2 from the second enhancement element 122 can be improved in comparison with the detection light L2 reflected by the display layer 330, which is conducive to improve the detection accuracy.

In other embodiments, the second enhancement element 122 may be other structures that can enhance light intensity, such as a luminance-enhancing film.

The light-receiving assembly 120 further includes an image sensor 123 on the optical path of the detection light L2. The image sensor 123 is used to receive the detection light L2 from the second enhancement element 122, and also used to generate an image of the detection light L2 as sensed. In this embodiment, the image sensor 123 is a camera.

The image processor 130 is electrically connected to the image sensor 123 to receive the image generated by the image sensor 123 and to determine whether the surface 331 of the display layer 330 in the display device 300 is flat according to the image.

The image processor 130 of the present disclosure may be a circuit, a data processing chip, a chipset, or a computer. The image sensor 123 and the image processor 130 are electrically or wirelessly connected. In this embodiment, the image processor 130 is a computer, which can obtain a result of detection according to the image and can display the result by an image or in the form of a table, which is convenient for users to view.

According to Brewster’s law, when linearly polarized light within certain wavelengths enters a medium at the Brewster’s angle, if its light vibration surface is parallel to an incident surface, intensity of light reflected by the incident surface is 0. That is, the light is passed through completely without being reflected. In this embodiment, the reference light L1 is an incident light, and the glass cover plate 310 is an incident medium. By setting an incident angle of the reference light L1 to 56.3° (the Brewster angle between the glass cover plate 310 and the air is 56.3°), the reference light L1 is completely passed through by the glass cover plate 310. Moreover, in this embodiment, a refractive index of the glass cover plate 310 and the touch layer 320 are basically the same, and the reference light L1 is completely passed through the touch layer 320 and can be reflected by the display layer 330 after reaching the display layer 330.

The optical detection apparatus 100 of this embodiment includes the light-emitting assembly 110 and the light-receiving assembly 120. The light-emitting assembly 110 is used to emit the reference light L1 and includes the first enhancement element 112. By setting the incident angle of the reference light L1 to be equal to the Brewster angle between the glass cover plate 310 and the air, almost all the reference light L1 is completely passed through the glass cover plate 310 and the touch layer 320 and can reach the display layer 330. The first enhancement element 112 is used to enhance the intensity of the reference light L1 so that the reference light L1 can reach the surface 331 of the display layer 330 through the glass cover plate 310. Therefore, the optical detection apparatus 100 of this embodiment can directly detect the flatness of the surface 331 of the display layer 330. Since the display from the display device 300 is mainly affected by the flatness of the surface 331 of the display layer 330, this embodiment prevents a problem of poor display caused by the uneven surface 331 of the display layer 330 by detecting the flatness of the surface 331 of the display layer 330.

The optical detection apparatus 100 further includes the light-receiving assembly 120 including a second enhancement element 122 for enhancing the brightness of the detection light L2, which improves the detecting accuracy.

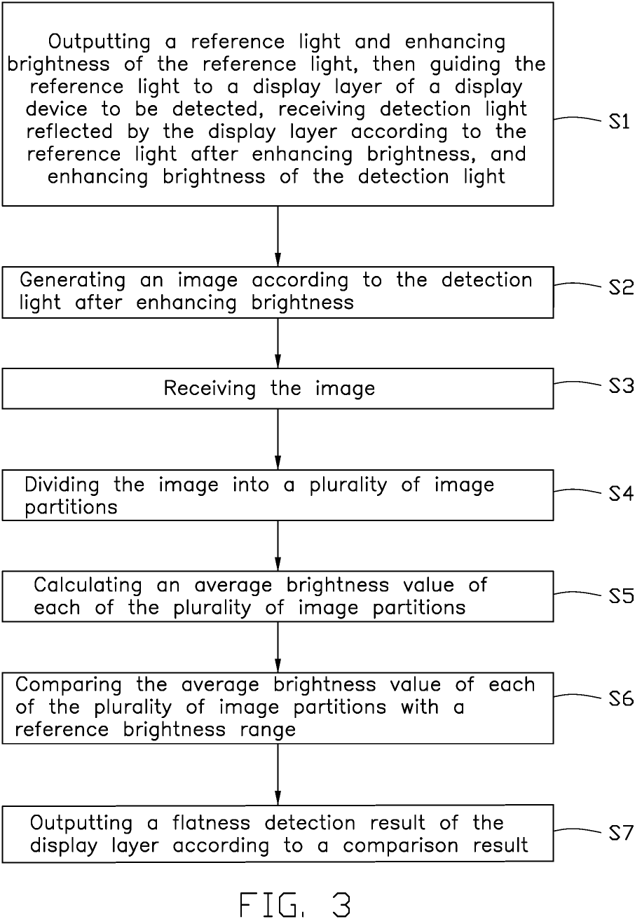

Referring to FIG. 3, a flowchart is presented in accordance with an example embodiment which is being thus illustrated. The example method is provided by way of example, as there are a variety of ways to carry out the method. The method described below can be carried out using the configurations illustrated in FIGS. 1 and 2, for example, and various elements of these figures are referenced in explaining example method. Each block shown in FIG. 3 represents one or more processes, methods or subroutines, carried out in the exemplary method. Additionally, the illustrated order of blocks is by example only and the order of the blocks can change according to the present disclosure. The exemplary method can begin at block S1.

block S1, outputting a reference light and enhancing brightness of the reference light, then guiding the reference light to a display layer of a display device to be detected, receiving detection light reflected by the display layer according to the reference light after enhancing brightness, and enhancing brightness of the detection light;

block S2, generating an image according to the detection light after enhancing brightness.

block S3, receiving the image.

block S4, dividing the image into a plurality of image partitions.

block S5, calculating an average brightness value of each of the plurality of image partitions.

block S6, comparing the average brightness value of each of the plurality of image partitions with a reference brightness range.

block S7, outputting a flatness detection result of the display layer according to a comparison result.

The blocks S1 through S7 are applied to the optical detection apparatus 100, and the blocks S3 through S7 are applied to the image processor 130.

In this embodiment, before the block S2, the block S1 also performs noise processing on the image for removal of noise strengthen the clarity of image, which is conducive to improve an accuracy of the detection result.

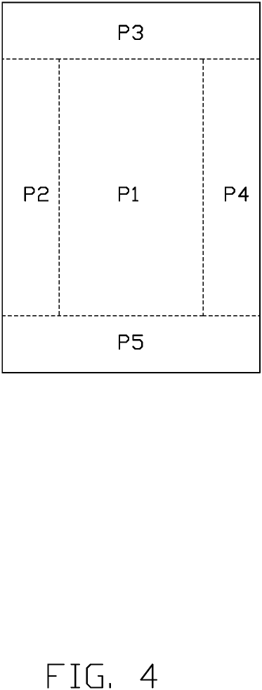

As shown in FIG. 4, in this embodiment, the block S4 includes dividing the image into a central image partition and a plurality of surrounding image partitions surrounding the central image partition. For example, the sensing image is divided into five image partitions that are P1, P2, P3, P4, and P5. The image partition P1 is in the central area of the image and is defined as the central image partition, while the image partitions P2, P3, P4, and P5 are the surrounding image partitions in the surrounding area of the image, wherein the image partitions P2, P3, P4, and P5 surround the image partition P1. The image partitions P1, P2, P3, P4, and P5 are spliced with each other to form the image.

The reference brightness range is pre-stored for the image processor 130. In the block S13, the average brightness values of the image partitions P1, P2, P3, P4, and P5 are obtained respectively. The block S5 determines whether a difference between a maximum average brightness value and a minimum average brightness value of the image partitions P1, P2, P3, P4, and P5 is within the particular reference brightness range. If the difference is within the reference brightness range, it indicates that a brightness difference of the image partitions P1, P2, P3, P4, and P5 is acceptably low, and the surface 331 of the display layer 330 in the display device 300 is flat. If the difference exceeds the reference brightness range, it indicates that the brightness difference of the image partitions P1, P2, P3, P4, and P5 is not acceptable, and the surface 331 of the display layer 330 in the display device 300 cannot be deemed flat, which will affect images displayed by the display device 300. In this embodiment, the reference brightness range is, for example, 0-50 nit (NIT).

In at least one embodiments of the present disclosure, the block S7 directly outputs the detection result, such as the message to user of “flatness is unqualified / is qualified”. In some embodiments, the block S7 can also directly output the detection image and mark an image partition with a large difference in the average brightness value. In other embodiments, the block S7 can also output various data calculated in the optical detection method, such as the brightness average value of each image partition P1, P2, P3, P4, and P5 calculated in the block S4, and the difference between the brightness average values calculated in the block S5, etc.

The optical detecting method of this embodiment can realize all the beneficial effects of the optical detection apparatus 100. On this basis, the optical detecting method in this embodiment divides the image by the block S4, calculates the brightness average value of each image partition by the block S5, compares the difference of the brightness average value of each image partition with the reference brightness range by the block S6, which is conducive to improve the detecting accuracy.

The embodiments shown and described above are only examples. Many details are often found in the art such as the other features of an optical detection apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical detection apparatus comprising:
a light-emitting assembly comprising a light source and a first enhancement element, the light source emitting reference light, the first enhancement element being positioned on an optical path of the reference light, the first enhancement element enhancing brightness of the reference light and guiding the reference light with enhanced brightness to a display layer of a display device;
a light-receiving assembly receiving a detection light reflected by the display layer according to the reference light and generating a sensing image according to the detection light; and
an image processor connected with the light-receiving assembly, the image processor being configured to receive the sensing image and obtain a detection result of a surface flatness of the display layer according to the sensing image.

2. The optical detection apparatus of claim 1, wherein the first enhancement element is a lens.

3. The optical detection apparatus of claim 1, wherein the first enhancement element is a luminance-enhancing film.

4. The optical detection apparatus of claim 1, wherein the light-emitting assembly further comprises a first selection element positioned on the optical path of the reference light from the first enhancement element; and
the first selection element guides a part of the reference light to the display layer.

5. The optical detection apparatus of claim 4, wherein the first enhancement element diffuses the reference light; and
the first selection element does not guide the reference light which is diffused to the display layer.

6. The optical detection apparatus of claim 5, wherein a divergence angle of the diffused light is greater than that of non-diffused reference light.

7. The optical detection apparatus of claim 4, wherein the first selection element is a polarizer.

8. The optical detection apparatus of claim 4, wherein the first selection element is a partially coated filter.

9. The optical detection apparatus of claim 1, wherein the reference light is a linearly polarized light.

10. The optical detection apparatus of claim 9, wherein the display device further comprises a glass cover plate, the glass cover plate transmits the reference light to the display layer, wherein the reference light incidents on a surface of the glass cover plate away from the display layer at a Brewster angle.

11. The optical detection apparatus of claim 1, wherein the reference light is white light.

12. The optical detection apparatus of claim 1 further comprising a carrier carrying and fixing the display device.

13. The optical detection apparatus of claim 1, wherein the light-receiving assembly comprises a second selection element, a second enhancement element, and an image sensor;
the second selection element is on an optical path of the detection light and guides part of the detection light to the second enhancement element;
the second enhancement element receives the detection light from the second selection element and enhances brightness of the detection light;
the image sensor receives the detection light from the second enhancement element and generates the sensing image according to the detection light, the image sensor is connected to the image processor for receiving the sensing image.

14. The optical detection apparatus of claim 1, wherein the image processor is electrically connected to the light-receiving assembly.

15. The optical detection apparatus of claim 1, wherein the image processor is wirelessly connected to the light-receiving assembly.

16. An optical detecting method comprising:
receiving a sensing image corresponding to a display layer of a display device;
dividing the sensing image into a plurality of image partitions;
calculating an average brightness value of each of the plurality of image partitions;
determining whether a maximum difference of the average brightness values of the plurality of image partitions is within a reference brightness range; and
outputting a flatness detection result of the display layer according to a determination.

17. The optical detecting method of claim 16, wherein the sensing image is divided into a plurality of image partitions by:
dividing the sensing image into a central image partition and a plurality of surrounding image partitions surrounding the central image partition.

18. The optical detecting method of claim 16, wherein before receiving a sensing image, the optical detecting method further comprises:
outputting a reference light and enhancing brightness of the reference light, guiding the reference light with enhanced brightness to the display layer of the display device, receiving detection light reflected by the display, and enhancing brightness of the detection light; and
generating a sensing image according to the detection light with enhanced brightness.

19. The optical detecting method of claim 16, wherein the reference brightness range is 0-50 nit.

20. An image processor, the image processor storing one or more programs, a method being realized when the one or more programs being executed by the image processor, the method comprising:
receiving a sensing image corresponding to a display layer of a display device;
dividing the sensing image into a plurality of image partitions;
calculating an average brightness value of each of the plurality of image partitions;
determining whether a maximum difference of the average brightness values of the plurality of image partitions is within a reference brightness range; and
outputting a flatness detection result of the display layer according to a determination.
